(19) United States
(12) Patent Application Publication
(10) Pub. No.: US 2026/0051533 A1
(43) Pub. Date: Feb. 19, 2026

(54) ANODE SUPPORTED SOLID-STATE ELECTROLYTE SEPARATORS

(71) Applicant: GM Global Technology Operations LLC, Detroit, MI (US)

(72) Inventors: Yifan Zhao, Troy, MI (US); Yun-Yu Lai, Clawson, MI (US); Thomas A. Yersak, Royal Oak, MI (US); Raneen Taha, Sterling Heights, MI (US); Zhe Li, Shanghai (CN); Qili Su, Shanghai (CN)

(21) Appl. No.: 18/809,811

(22) Filed: Aug. 20, 2024

(30) Foreign Application Priority Data
Aug. 13, 2024 (CN) 202411112972.X

(51) Int. Cl. H01M 10/056; B60L 50/64; H01M 4/02; H01M 4/38; H01M 4/48; H01M 4/587; H01M 10/0525; H01M 50/446

(52) U.S. Cl. CPC H01M 10/056; B60L 50/64; H01M 4/386; H01M 4/48; H01M 4/587; H01M 10/0525; H01M 50/446; H01M 2004/027; H01M 2220/20; H01M 2300/0065; H01M 2300/0091

(57) ABSTRACT

An anode electrode for a battery cell, a battery cell, and a method of forming an anode supported electrolyte separator. The anode electrode includes an anode current collector including a first surface and an anode supported electrolyte separator disposed on the first surface. The anode supported electrolyte separator includes at least one electrolyte selected from the following compositions: a) yLi₂S·(100-y-x)P₂S₅·xP₂O₅ wherein y is in the range of 70 mole percent to 80 mole percent and x is in the range of 1 mole percent to 10 mole percent, b) Li₁₀MP₂S₁₂ wherein M is at least one of Si, Ge, and Sn, and c) argyrodite. In addition, the anode supported electrolyte separator exhibits a thickness in the range of 1 micrometers to 100 micrometers.

### BACKGROUND

Electric and hybrid electric vehicle technology is enabled by the development and deployment of rechargeable, secondary batteries, which provide energy to the vehicle powertrain. Secondary batteries include lithium ion batteries, which generally include one or more battery cells, each including a cathode, anode, separator, and electrolyte. The cathode provides the source of lithium ions and determines the capacity and average voltage of a battery. The anode stores and releases lithium ions received from the cathode when energy is needed. The separator, typically a polymeric film or sheet, prevents the cathode and anode from contacting and shorting out the battery, and the electrolyte provides a medium between the cathode and anode through which the lithium ions travel. In some systems, a solid state electrolyte may be used instead of a separator, which is a solid material that is an ionic conductor, particularly a lithium ionic conductor, that also blocks the passage of electrons preventing the battery cell from shorting. Using a solid state electrolyte as a separator may also eliminate the need for a separate electrolyte.

Often lithium-ion batteries are assembled by stacking a cathode, a stand-alone separator, and an anode together, placing the stack into packaging and forming a battery cell, adding an electrolyte to the battery cell, and connecting a number of battery cells together. Stand-alone separators are self-supporting structures and generally exhibit a thickness of 100 micrometers or greater. Reducing the thickness of the self-supporting separators provides improvement in battery cell energy density. Reducing the thickness of the separator may also reduce the ability of the separator to be self-supporting.

To reduce the thickness of the separator and battery cell efforts have been made to support the separator by depositing the separator directly onto the anode or cathode and using a solid state electrolyte as the separator. However, lithium metal anodes are generally not compatible with the casting process often used to deposit the separator onto the anode. Cathode-supported separators are more compatible with the casting process for depositing a separator onto the cathode. In addition, cathode separators exhibit a thickness in the range of 20 micrometers to 50 micrometers. However, the anode typically exhibits a relatively larger area than the cathode, which causes the anode to overhang the cathode. Such a design is subject to edge shorting as the overhang on the anode may contact the cathode. While one solution is to increase the surface area of the cathode, it is desirable to develop a separator that can be deposited directly on the anode.

Thus, while present separators achieve their intended purpose, there is a need for new and improved anode and separator designs.

### SUMMARY

According to various aspects, the present disclosure relates to an anode electrode for a battery cell. The anode electrode includes an anode current collector including a first surface and an anode supported electrolyte separator disposed on the first surface. The anode supported electrolyte separator includes at least one electrolyte selected from the following compositions: a) yLi₂S·(100-y-x)P₂S₅·xP₂O₅ wherein y is in the range of 70 mole percent to 80 mole percent and x is in the range of 1 mole percent to 10 mole percent, b) Li₁₀MP₂S₁₂ wherein M is at least one of Si, Ge, and Sn, and c) argyrodite exhibiting the composition: A₁₂₋ₘ₋ₓ⁺(M^{m+}Y₄²⁻)Y₂₋ₓ²⁻Xₓ⁻ wherein A⁺=Li⁺, Cu⁺, Ag⁺; M^{m+}=Si⁴⁺, Ge⁴⁺, Sn⁴⁺, P⁵⁺, As⁵⁺; Y²⁻=O²⁻, S²⁻, Se²⁻, Te²⁻; X⁻=Cl⁻, Br⁻, I⁻; and 0≤x≤2. In addition, the anode supported electrolyte separator exhibits a thickness in the range of 1 micrometers to 100 micrometers.

In embodiments of the above, the anode supported electrolyte separator includes a second surface defining a second area, wherein the second area is larger than a third area defined by a third surface of an adjacent cathode.

In any of the above embodiments, the anode supported electrolyte separator contacts the first surface of the anode current collector.

Alternatively, the anode electrode further includes an anode contacting the first surface, wherein the anode includes a fourth surface defining a fourth area, and the anode supported electrolyte separator contacts the fourth surface.

In embodiments of the above, the anode includes one or more active anode materials selected from the group consisting of: silicon, silicon-carbon composite, hard carbon, graphite, silicon oxide (SiOx, wherein x is either 1 or 2), and lithium titanate (LTO). In further embodiments, the anode includes silicon exhibiting a thickness in the range of 1 micrometers to 50 micrometers.

In any of the above embodiments, the electrolyte is yLi₂S·(100-y-x)P₂S₅·xP₂O₅ wherein y is in the range of 70 mole percent to 80 mole percent and x is in the range of 1 mole percent to 10 mole percent and the electrolyte is present in the range of 50 percent by weight to 99 percent by weight of the total weight of the anode supported electrolyte separator and the anode supported electrolyte separator further includes an electrolyte binder present in the range of 1 percent by weight to 50 percent by weight of the total weight of the anode supported electrolyte separator. In further embodiments, the electrolyte binder includes one or more binders selected from the group consisting of: styrene butadiene rubber (SBR), hydrogenated nitrile butadiene rubber (HNBR), polyvinylidene fluoride (PVDF), poly(vinylidene fluoride-co-hexafluoropropylene) (PVDF-HFP), polytetrafluoroethylene (PTFE), and poly(tetrafluoroethylene-co-perfluoro(3-oxa-4-pentenesulfonic acid)) lithium salt.

In any of the above embodiments, the anode supported electrolyte separator further includes one or more liquid electrolyte diluents selected from the group consisting of: 1,1,2,2-tetrafluoroethylene 2,2,3,3-tetrafluoropropyl ether (TTE), bis(2,2,2-trifluoroethyl) ether (BTFE), tris(2,2,2-trifluoroethyl)orthoformate (TFEO), fluorobenzene (FB), 1,2-difluorobenzene (DFB), bis(2,2-difluoroethyl) ether (BDE), ethyl 1,1,2,2-tetrafluoroethyl ether (ETE), hexafluoroisopropyl methyl ether (HFME), 1,1,2,2-tetrafluoroethyl 2,2,2-trifluoroethyl ether, ethyl 1,1,2,3,3,3-hexafluoropropyl ether, methyl nonafluorobutyl ether (mixture of isomers), difluoromethyl 2,2,3,3-tetrafluoropropyl ether, 1H,1H,5H-octafluoropentyl 1,1,2,2-tetrafluoroethyl ether (OTE), 1,1,2,3,3,3 hexafluoropropyl-2,2,2-trifluoroethyl ether, 1,1,1,2,2,3,4,5,5,5-decafluoro-3-methoxy-4-(trifluoromethyl)pentane, fluoromethyl 1,1,1,3,3,3-hexafluoroisopropyl ether, 1,1,2,3,3,3-hexafluoropropyl methyl ether, methyl 2,2,3,3,3-pentafluoropropyl ether, and methyl 1,1,2,2-tetrafluoroethyl ether.

In any of the above embodiments, the anode supported electrolyte separator further includes one or more room temperature ionic liquids selected from the group consisting of: 1-ethyl-3-methylimidazolium bis(trifluoromethylsulfonyl)imide (EMIM-TFSI), 1-butyl-3-methylimidazolium bis(trifluoromethylsulfonyl)imide (BMIM-TFSI), N-propyl-N-methylpyrrolidinium bis(trifluoromethanesulfonyl)imide (PYR13TFSI), 1-butyl-1-methylpyrrolidinium bis(trifluoromethanesulfonyl)imide (PYR14TFSI), 1-ethyl-3-methylimidazolium bis(fluorosulfonyl)imide (EMIM-FSI), 1-butyl-3-methylimidazolium bis(fluorosulfonyl)imide (BMIM-FSI), N-propyl-N-methylpyrrolidinium bis(fluorosulfonyl)imide (PYR13-FSI), and 1-butyl-1-methylpyrrolidinium bis(fluorosulfonyl)imide (PYR14-FSI).

In any of the above embodiments, the anode supported electrolyte separator includes one or more solvate ionic liquid electrolytes selected from the group consisting of: lithium triglyme bis(trifluoromethanesulfonyl)imide (Li[G3]TFSI), lithium tetraglyme bis(trifluoromethanesulfonyl)imide (Li[G4]TFSI), lithium triglyme bis(fluorosulfonyl)imide (Li[G3]FSI), lithium tetraglyme bis(fluorosulfonyl)imide (Li[G4]FSI), lithium triglyme bis(pentafluoroethenesulfonyl)imide (Li[G3]BETI), lithium tetraglyme bis(pentafluoroethenesulfonyl)imide (Li[G4]BETI), lithium triglyme cyclic-TFSI derivative 1,2,3-dithiazolidine-4,4,5,5-tetrafluoro-1,1,3,3-tetraoxide (Li[G3]CTFSI), lithium tetraglyme cyclic-TFSI derivative 1,2,3-dithiazolidine-4,4,5,5-tetrafluoro-1,1,3,3-tetraoxide (Li[G4]CTFSI), lithium triglyme perchlorate (Li[G3]ClO₄), lithium tetraglyme perchlorate (Li[G4]ClO₄), lithium triglyme tetrafluoroborate (Li[G3]BF₄), and lithium tetraglyme tetrafluoroborate (Li[G4]BF₄).

According to various additional aspects, the present disclosure relates to a battery cell for use in a vehicle battery. In embodiments, the battery cell includes any of the above described anode electrodes. In embodiments, the battery cell includes an anode current collector including a first surface, an anode supported electrolyte separator disposed on the first surface, the anode supported electrolyte separator including a second surface defining a second area, and a cathode adjacent to the second surface of the anode supported electrolyte separator, the cathode including a third surface defining a third area. The second area is greater than the third area and the anode supported electrolyte separator includes an overhang that extends beyond the third area of the cathode. In addition, the anode supported electrolyte separator exhibits a thickness in the range of 1 micrometers to 100 micrometers. Further, the anode supported electrolyte separator includes at least one of the following electrolyte compositions: a) yLi₂S·(100-y-x)P₂S₅·xP₂O₅ wherein y is in the range of 70 mole percent to 80 mole percent and x is in the range of 1 mole percent to 10 mole percent, b) Li₁₀MP₂S₁₂ wherein M is at least one of Si, Ge, and Sn, and c) argyrodite exhibiting the following composition: A₁₂₋ₘ₋ₓ⁺(M^{m+}Y₄²⁻)Y₂₋ₓ²⁻Xₓ⁻ wherein A⁺=Li⁺, Cu⁺, Ag⁺; M^{m+}=Si⁴⁺, Ge⁴⁺, Sn⁴⁺, P⁵⁺, As⁵⁺; Y²⁻=O²⁻, S²⁻, Se²⁻, Te²⁻; X⁻=Cl⁻, Br⁻, I⁻; and 0≤x≤2, present in the range of 50 percent by weight to 99 percent by weight of the total weight of the anode supported electrolyte separator, and an electrolyte binder present in the range of 1 percent by weight to 50 percent by weight of the total weight of the anode supported electrolyte separator.

In embodiments of the above, the anode supported electrolyte separator contacts the anode current collector.

Alternatively, the battery cell further includes an anode including silicon and a fourth surface defining a fourth area, the anode contacting the first surface of the anode current collector and the anode supported electrolyte separator contacting the fourth surface of the anode.

In any of the above embodiments, the overhang is in the range of 1 millimeter to 2 millimeters.

In any of the above embodiments, the anode current collector is a bipolar current collector.

In any of the above embodiments, the battery cell further includes a cathode current collector and the cathode contacts the cathode current collector.

In any of the above embodiments, the cathode includes an active cathode material, a cathode electrolyte, and a cathode binder. The active cathode material is present in the range of 64 percent by weight to 98.5 percent by weight of the total weight of the cathode, the cathode binder present in the range of 1 percent by weight to 9 percent by weight of the total weight of the cathode, and the cathode electrolyte is present in the range of 10 percent by weight to 17 percent by weight of the total weight of the cathode. In addition, the active cathode material includes one or more active cathode materials selected from the following: lithium iron phosphate (LFP), sulfur(S), iron sulfide (FeS₂), and lithium sulfide (Li₂S), and the cathode binder includes one or cathode binders selected from the group consisting of styrene butadiene rubber (SBR), hydrogenated nitrile butadiene rubber (HNBR), polyvinylidene fluoride (PVDF), poly(vinylidene fluoride-co-hexafluoropropylene) (PVDF-HFP), polytetrafluoroethylene (PTFE) poly(ethylene oxide) (PEO) and poly(tetrafluoroethylene-co-perfluoro(3-oxa-4-pentenesulfonic acid)) lithium salt, and the cathode electrolyte includes yLi₂S·(100-y-x)P₂S₅·xP₂O₅ wherein y is in the range of 70 mole percent to 80 mole percent and x is in the range of 1 mole percent to 10 mole percent.

In any of the above embodiments, the anode supported electrolyte separator includes a room temperature ionic liquid and the room temperature ionic liquid is selected form one or more of the following room temperature ionic liquids: 1-ethyl-3-methylimidazolium bis(trifluoromethylsulfonyl)imide (EMIM-TFSI), 1-butyl-3-methylimidazolium bis(trifluoromethylsulfonyl)imide (BMIM-TFSI), N-propyl-N-methylpyrrolidinium bis(trifluoromethanesulfonyl)imide (PYR13TFSI), 1-butyl-1-methylpyrrolidinium bis(trifluoromethanesulfonyl)imide (PYR14TFSI), 1-ethyl-3-methylimidazolium bis(fluorosulfonyl)imide (EMIM-FSI), 1-butyl-3-methylimidazolium bis(fluorosulfonyl)imide (BMIM-FSI), N-propyl-N-methylpyrrolidinium bis(fluorosulfonyl)imide (PYR13-FSI), and 1-butyl-1-methylpyrrolidinium bis(fluorosulfonyl)imide (PYR14-FSI).

According to yet additional aspects, the present disclosure relates to a method of forming an anode supported electrolyte separator. The method includes forming a slurry of an electrolyte and an electrolyte binder in a binder solvent, coating the slurry on one of a) a first surface of an anode current collector and b) a second surface of an anode, drying the slurry to form an anode supported electrolyte separator, and calendaring the anode supported electrolyte separator. The at least one electrolyte includes a composition selected from the group consisting of: a) yLi2S·(100-y-x)P2S5·xP2O5 wherein y is in the range of 70 mole percent to 80 mole percent and x is in the range of 1 mole percent to 10 mole percent, b) Li₁₀MP₂S₁₂ wherein M is at least one of Si, Ge, and Sn, and c) argyrodite exhibiting the following composition: A₁₂₋ₘ₋ₓ⁺(M^{m+}Y₄²⁻)Y₂₋ₓ²⁻Xₓ⁻ wherein A⁺=Li⁺, Cu⁺, Ag⁺; M^{m+}=Si⁴⁺, Ge⁴⁺, Sn⁴⁺, P⁵⁺, As⁵⁺; Y²⁻=O²⁻, S²⁻, Se²⁻, Te²⁻; X⁻=Cl⁻, Br⁻, I⁻; and 0≤x≤2. In addition, the anode supported electrolyte separator exhibits a thickness in the range of 1 micrometers to 100 micrometers.

### BRIEF DESCRIPTION OF DRAWINGS

The drawings described herein are for illustration purposes only and are not intended to limit the scope of the present disclosure in any way.

FIG. 1 illustrates a vehicle and a power train including a secondary battery according to embodiments of the present disclosure.

FIG. 2A illustrates a battery according to embodiments of the present disclosure.

FIG. 2B illustrates a pouch or prismatic battery cell according to embodiments of the present disclosure.

FIG. 2C illustrates a cylindrical battery cell according to embodiments of the present disclosure.

FIG. 2D illustrates a coin battery cell according to embodiments of the present disclosure.

FIG. 3A illustrates building blocks for a bipolar battery cell design according to embodiments of the present disclosure.

FIG. 3B illustrates a bipolar battery cell design according to embodiments of the present disclosure.

FIG. 4A illustrates a side view of a battery cell stack according to embodiments of the present disclosure.

FIG. 4B a front view of a battery cell stack according to embodiments of the present disclosure.

FIG. 5 illustrates a method of forming an anode supported solid state electrolyte or semi-solid state electrolyte according to embodiments of the present disclosure.

FIG. 6 illustrates a method of coating an anode with a solid state electrolyte or a semi-solid state electrolyte according to embodiments of the present disclosure.

FIG. 7 illustrates a side view of a traditional battery cell stack including a self-supporting polymer separator.

FIG. 8 illustrates a side view of a cathode supported solid state electrolyte separator.

FIG. 9 illustrates the change in capacity (milli-Amp hours) of a traditional battery cell over 80 cycles employing a polymer separator, wherein the capacity is illustrated on the y-axis and the cycle number is illustrated on the x-axis.

FIG. 10 illustrates the change in capacity (milli-Amp hours) of a battery cell including an anode supported solid state electrolyte separator over 80 cycles, wherein the capacity is illustrated on the y-axis and the cycle number is illustrated on the x-axis.

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale.

The present disclosure relates to an anode supported electrolyte separators and a method of forming anode supported electrolyte separators. In various aspects, the anodes including the supported electrolyte separator are incorporated into battery cells and secondary batteries, such as prismatic, pouch, cylindrical, or coin style battery cells. The batteries may then be used in electric or hybrid-electric vehicles.

As used herein, the term “vehicle” is not limited to automobiles. While the present technology is described primarily herein in connection with electric and hybrid-electric vehicles, the technology is not limited to electric and hybrid-electric vehicles. The concepts can be used in a wide variety of applications, such as in connection with components used in motorcycles, mopeds, locomotives, aircraft, marine craft, and other vehicles, as well as in other applications utilizing batteries, such as consumer electronics, power banks for buildings, and portable power stations used for powering remote job sites, emergency back-up power supplies, and permanent power stations associated with buildings and equipment, all of which may be powered by, for example, solar or wind-powered generator systems, power mains, and fuel based power generators such as gasoline, propane, kerosene, or diesel generators as well as sterling engines.

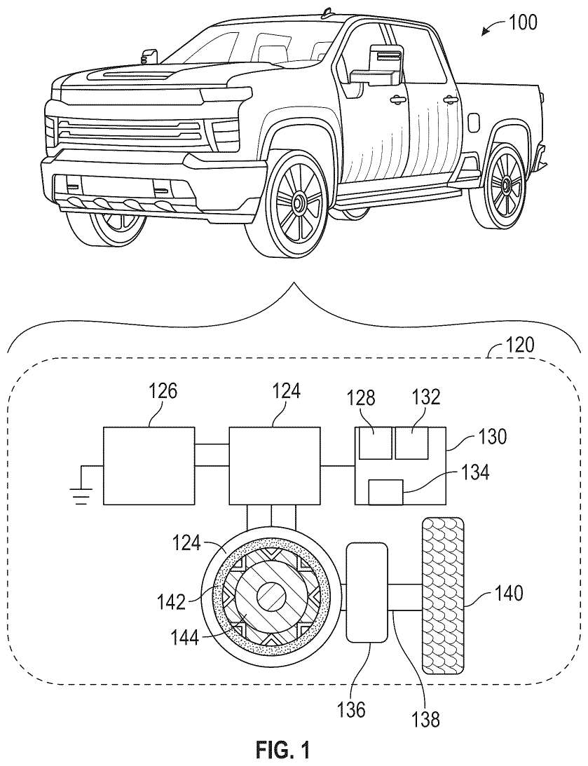

FIG. 1 illustrates a vehicle 100 including a propulsion system 120. The propulsion system 120 generally includes an electric motor 124 and a secondary battery 126 for powering the electric motor 124. Further, in many embodiments of the propulsion system 120, the propulsion system 120 includes an inverter 128 for changing power from DC (direct current) as provided by the battery 126 to AC (alternating current) as it is used by the electric motor 124. The inverter 128 may be included in a power electronics module 130, which includes e.g., transistors and diodes, for switching the power from DC to AC and vice-versa.

A controller 132 is connected to the inverter 128 and is programmed to control and manage the operations of the electric motor 124 and associated hardware, including the inverter 128. The electric motor 124 is connected to a transmission (drive unit) 136, and drive line 138, which transfers mechanical power and rotation to the wheels 140 of the vehicle 100. The controller 132 includes one or more one or more processors and tangible, non-transitory memory 134. A combustible fuel powered engine may also be included in the propulsion system of hybrid-electric vehicles.

With reference again to the electric motor 124, the electric motor 124 is powered by the battery 126 and includes a stator 142 and a rotor 144 arranged with the stator 142. The stator 142 is the stationary part of the electric motor 124. The stator 142 provides a rotating magnetic field with which the stationary magnetic field of the rotor 144 tries to align, causing the rotor 144 to rotate, in what may be referred to as “motoring” mode. In other applications the rotor's 144 rotating field (as caused by physical rotation) generates an electric current in the stator 142—this mode of operation is referred to as “generation” mode and the electric motor 124 used in this way is referred to as generator. In traction motor vehicle applications, the motoring mode provides motion to the vehicle 100. Generation mode takes some of the energy recovered from braking when the vehicle is in the process of stopping and stores it back in the vehicle battery 126.

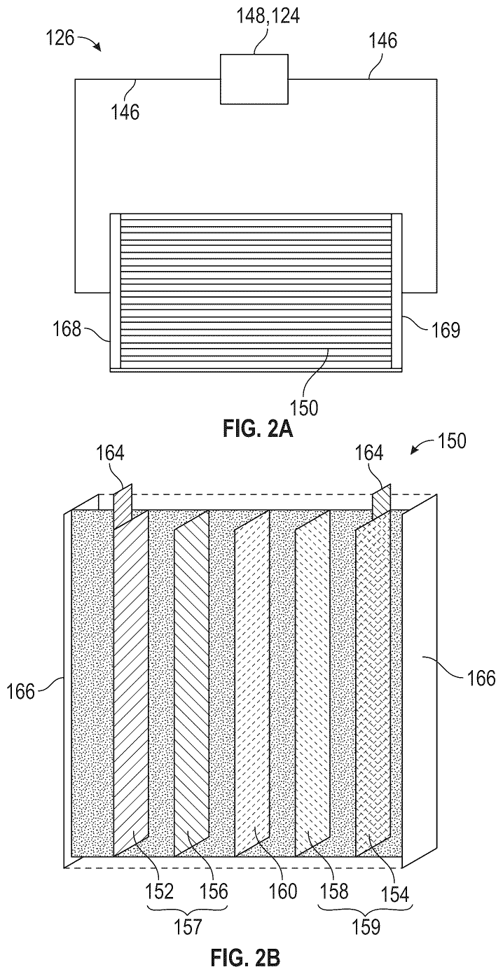

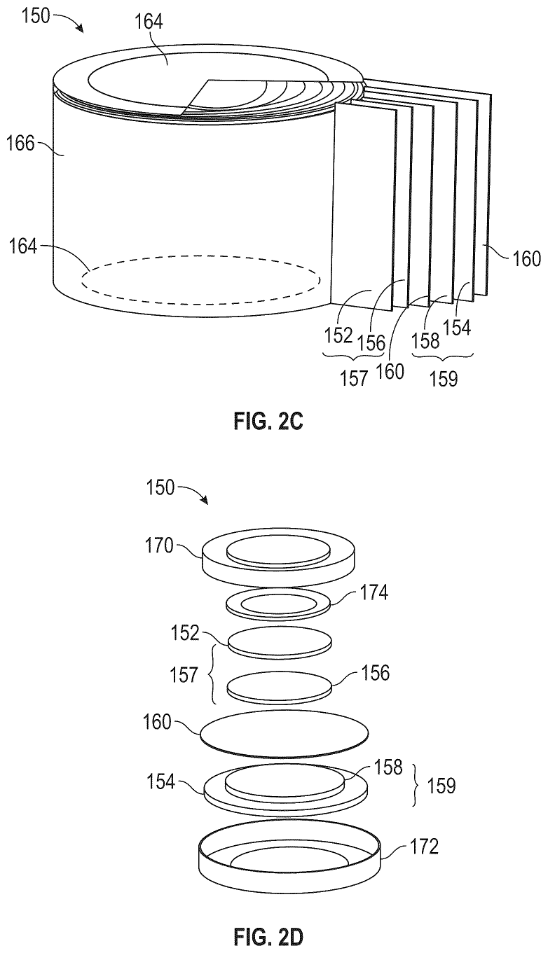

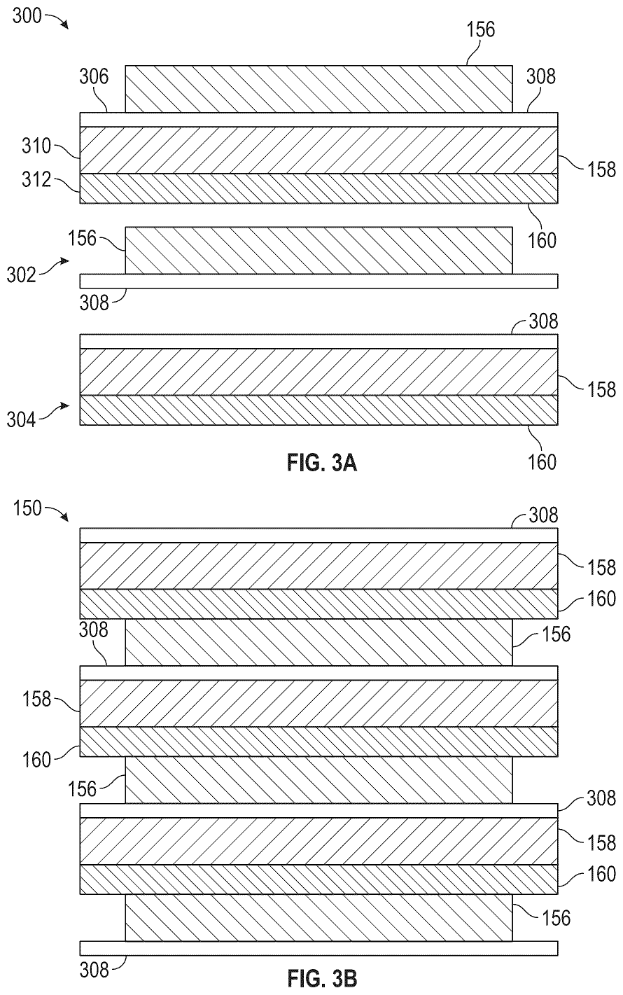

Reference is made to FIGS. 2A, 2B, 2C, 2D, 3A and 3B illustrating examples of secondary batteries 126 for powering an electric vehicle 100, such as the electric vehicle 100 illustrated in FIG. 1. As noted above, secondary batteries 126 are understood as rechargeable batteries, that may be discharged upon application of a load and recharged upon the application of an external power source. Referring to FIGS. 2A, 2B, 2C and 2D, the battery 126 is illustrated as being connected to a load 148, such as the electric motor 124. However, other loads 148 include various systems in the vehicle 100 such as climate control systems and infotainment systems. The battery 126 includes one or more battery cells 150, that are assembled together. The battery cells 150 may be, for example, pouch style, prismatic, cylindrical or coin, discussed further below. With reference to FIGS. 2B, 2C, and 2D, during discharge, when a load 148 is applied to the battery 126, Li+ ions move from the anode 158 to the cathode 156 through the separator 160, which also provides the electrolyte 162. Equivalent electrons e− move through the circuitry 146 from the cathode 156 to the anode 158, providing voltage to the load 148. While charging, upon application of an external voltage, Li+ ions move from the cathode 156 to the anode 158 through the anode supported electrolyte separator 160 and may be intercalated into the anode 158.

Each battery cell 150, such as those illustrated in FIGS. 2B, 2C and 2D, generally includes a cathode current collector 152, a cathode 156 disposed on the cathode current collector 152, an anode current collector 154, an anode 158 disposed on the anode current collector 154, and an anode supported electrolyte separator 160 positioned between the cathode 156 and anode 158. While unipolar solid state battery cell arrangements are illustrated below in FIGS. 2B through 2D, including a cathode current collector 152, a cathode 156, an anode current collector 154, an anode 158, and a solid state electrolyte separator 160 for each unit of the battery cell 150, it should be appreciated that alternative arrangements may also be used, such as battery cells 150 including cathodes 156 disposed on both sides of the cathode current collector 152, anodes 158 disposed on both sides of the anode current collector 154, and arrangements including multiple stacks of cathode current collectors 152, cathodes 156, anode current collectors 154, anodes 158, and anode supported electrolyte separators 160, as well as arrangements including bipolar battery cell designs, which are described further in FIGS. 3A and 3B.

In embodiments, the battery cell 150 of FIG. 2B is configured as a pouch style battery cell or in a prismatic battery cell. In either design, where multiple cathodes 156 and multiple anodes 158 are present, anode supported electrolyte separators 160 are provided between the cathodes 156 and anodes 158. In a pouch style cell, tabs 164 are welded to the cathode current collectors 152 and the anode current collectors 154 and the covering 166 is in the form of a flexible film pouch formed of aluminum or another material. Prismatic style cells, on the other hand, include terminals that the cathode current collectors 152 and anode current collectors 154 are connected to and the covering 166 is formed of a relatively rigid casing, typically in the form of a cuboid. The tabs 164, or terminals, connected to the cathode current collectors 152 from multiple battery cells 150 are connected together, such as by a bus bar 168 (see FIG. 2A) or other electrical connection, and the tabs 164, or terminals, connected to the anode current collectors 154 from multiple battery cells 150 are connected together, such as by a bus bar 169 (see FIG. 2A) or other electrical connection.

Alternatively, the battery cell 150 of FIG. 2C is configured as a cylinder style battery cell 150. In this design, the cathode current collector 152, anode current collector 154, cathode 156, anode 158, and one or more anode supported electrolyte separators 160 are in the form of long ribbons, which are rolled into a cylinder or jelly roll. Like the prismatic cell, the covering 166 is formed of a relatively rigid casing of aluminum or another material. Tabs 164 are welded to the cathode current collector 152 and anode current collector 154. The tabs 164 connected to the cathode current collectors 152 from multiple battery cells 150 are connected together, such as by a bus bar 168 (see FIG. 2A) or other electrical connection, and the tabs 164, or terminals, connected to the anode current collectors 154 from multiple battery cells 150 are connected together, such as by a bus bar 169 (see FIG. 2A) or other electrical connection.

In further alternative embodiments, the battery cell 150 is packaged in a coin cell as illustrated in FIG. 2D. In this design, the cathode current collector 152, anode current collector 154, cathode 156, anode 158, and anode supported electrolyte separators 160 are in the form of discs, which are sandwiched together in the coin packaging forming the covering 166, which includes a cap 170 and a can 172. A spring washer 174 may be included between 170 the cathode current collector 152 and the cap 170.

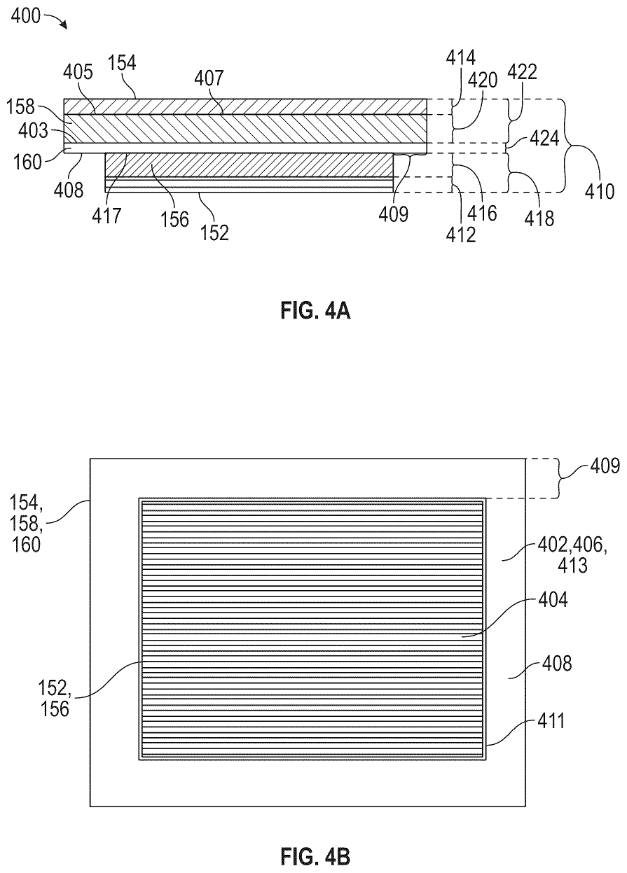

Bipolar battery cell designs include serially connected battery cells 150. The battery cells 150 include one or more current collectors that are bipolar. Each current collector includes a cathode 156 deposited on one side of the current collector and an anode 158 deposited on the other side of the current collector. Use of bipolar designs further increases energy density as packaging for individual battery cells may be eliminated and the number of connections between the battery cells may be reduced as current flows through the entire battery stack. Turning now to FIG. 3A, FIG. 3A illustrates embodiments of building blocks 300, 302, 304 for forming bipolar battery cells. Building block 300 includes a cathode 156 deposited on a first side 306 of a bipolar current collector 308, an anode 158 deposited on a second side 310 of the bipolar current collector 308 and an anode supported electrolyte separators 160 deposited on a surface 312 of the anode 158 that opposes the bipolar current collector 308. Building block 302 includes a cathode 156 deposited on a first side 306 of a bipolar current collector 308 and building block 304 includes an anode 158 deposited on a second side 310 of the bipolar current collector 308 and an anode supported electrolyte separators 160 deposited on a surface 312 of the anode 158 that opposes the current collector 308. The building blocks 300, 302, 304 are arranged to form a stack of cathodes 156 and anodes 158 including anode supported electrolyte separators 160 between the cathodes 156 and anodes 158 and bipolar current collectors 308 between each stack of a cathodes 156, an anodes supported electrolyte separator 160, and an anode 158, as illustrated in the embodiment of FIG. 3B. Multiple bipolar battery cells may be packaged in a single covering 166 resembling the packaging described above with reference to FIGS. 2A, 2B, 2C, and 2D. The bipolar collector 308 provides both the anode current collector 154 and cathode current collector 152 illustrated in FIGS. 2A through 2D, 4A and 4B.

In the various styles of battery cells 150 noted above and with further reference to FIGS. 4A and 4B, the anode supported electrolyte separator 160 is supported on and contacts a surface 403 of the anode 158 opposing the surface 405 of the anode 158 contacting a surface 407 of the anode current collector 154. Alternatively, as discussed further herein, the anode supported electrolyte separator 160 contacts the surface of the anode current collector 154. In either embodiment, the anode supported electrolyte separator 160 is disposed on the surface 407 of the anode current collector 154. In embodiments, the anode supported electrolyte separator 160 covers the entire surface 403 of the anode 158. In addition, the area 402, 406 of the anode 158 surface 403 and anode supported electrolyte separator 160, respectively, is selected to be larger than, and is larger, than the area 404 of the cathode 156 the anode supported electrolyte separator 160 is to be, and is, positioned adjacent to. In addition, the area 402 of the anode 158 exhibits the same as the area 406 of the anode supported electrolyte separator 160. This creates an overhang 408, i.e., an overlapping area 413 of the anode 158 and anode supported electrolyte separator 160 that overlaps and extends beyond the area 404 and perimeter 411 exhibited by a surface 415 of the cathode 156. The overhang 408 ranges in width 409 between 1 millimeter to 2 millimeters, including all values and ranges therein. In embodiments, the width 409 of the overhang 408 is consistent around the entire perimeter 411 of the cathode 156. Alternatively, the width 409 of the overhang 408 varies around the perimeter 411 of the cathode 156. It should be appreciated, however, that the overhang is sufficiently wide enough at any location around the perimeter 411 of the cathode 156 to separate the cathode 156 from the anode 158 should the anode 158 and the anode supported electrolyte separator 160 bend over and contact the cathode 156. The presence of the anode supported electrolyte separator 160 at the overhang 408 prevents electrical shorts from occurring should the overhang 408 fold over and contact the cathode 156 as the separator 160, and not the anode 158, will contact the cathode 156. The areas 402, 404, 406 being defined in a direction generally orthogonal to the thickness 410 of the stack and the surfaces 403, 405, 417 are generally perpendicular.

Further, with reference to FIGS. 2A through 4B, the cathode current collector 152, anode current collector 154, and bipolar current collector 308 are formed from conductive materials. In embodiments, the cathode current collector 152 includes aluminum. Alternatively, or additionally, the cathode current collector 152 may include copper clad aluminum, and stainless steel. In embodiments, the anode current collector 154 includes copper. Alternatively, or additionally, the anode current collector includes one or more of nickel, stainless steel, and titanium. In embodiments, the bipolar current collector 308 includes one or more of the following materials: aluminum, copper clad aluminum, stainless steel, copper, nickel and titanium. The current collectors 152, 154, 308 are illustrated as being in the form of a foil; however, it should be appreciated that other forms may be exhibited such as mesh. In embodiments, foil current collectors are impermeable to gas. The cathode current collector 152 exhibits a thickness 412 in the range of 5 micrometers to 50 micrometers, including all values and ranges therein, such as in the range of 5 micrometers to 25 micrometers. The anode current collector 154 exhibits a thickness 414 in the range of 4 micrometers to 50 micrometers, including all values and ranges therein, such as in the range of 4 micrometers to 25 micrometers. A bipolar current collector 308 exhibits a thickness in the range of 5 micrometers to 50 micrometers, including all values and ranges therein. In embodiments, either or both current collectors include surface roughening, increasing the surface area of the current collector.

The cathode 156 includes a source of lithium ions (Li⁺) and can undergo reversible insertion or intercalation of lithium ions, determining e.g., the capacity and average voltage of a battery. In embodiments, the cathode includes an active cathode material, a binder, optionally a cathode electrolyte, and optionally a conductive filler. The active cathode material includes one or more of the following active cathode materials: lithium iron phosphate (LFP), sulfur(S), iron sulfide (FeS₂), and lithium sulfide (Li₂S). In embodiments, the active cathode material also includes carbon black, wherein the carbon black is present in the range of 0.1 percent by weight to 40 percent by weight of the total weight of the active cathode material, including all values and ranges therein, wherein the total weight percent is 100 percent and the remainder weight percent includes the above reference active cathode materials. The binder includes one or more of the following cathode binders: styrene butadiene rubber (SBR), hydrogenated nitrile butadiene rubber (HNBR), polyvinylidene fluoride (PVDF), poly(vinylidene fluoride-co-hexafluoropropylene) (PVDF-HFP), polytetrafluoroethylene (PTFE), poly(ethylene oxide) (PEO) and poly(tetrafluoroethylene-co-perfluoro(3-oxa-4-pentenesulfonic acid)) lithium salt. The cathode electrolyte includes yLi₂S·(100-y-x)P₂S₅·xP₂O₅ wherein y is in the range of 70 mole (mol) percent to 80 mol percent including all values and ranges therein and x is in the range of 1 mol percent to 10 mol percent including all values and ranges therein (LPSO). The conductive filler includes on or more of metal wires, metal oxides, carbon nanotubes, carbon black, graphite flake, graphite nanoparticles, graphite nanoplates, and combinations thereof. In embodiments, the active cathode material is present in the range of 64 percent by weight to 98.5 percent weight of the total weight of the cathode including all values and ranges therein, the cathode binder is present in the range of 1 percent by weight to 9 percent by weight of the total weight of the cathode, including all values and ranges therein, optionally a cathode electrolyte present in the range of 10 percent by weight to 17 percent by weight of the total weight of the cathode including all values and ranges therein, and, optionally, a conductive filler is present in the range of 0.5 percent weight to 25 percent weight of the total weight of the cathode, including all values and ranges therein, wherein the total weight of the cathode equals 100 percent. In embodiments, the active cathode material, cathode binder, and conductive filler are deposited on the cathode 156 in a slurry that is deposited on the cathode current collector 152. The slurry is formed with a liquid, such as toluene, anisole, N-methyl-2-pyrrolidone (NMP), dimethylacetamide (DMAc), dimethylformamide (DMF), acetonitrile (MeCN).

The cathode 156 exhibits a thickness 416 in the range of 80 micrometers to 500 micrometers, including all values and ranges therein, such as 110 micrometers. The cathode electrode 157, including both the cathode current collector 152 and the cathode 156, exhibits a thickness 418 in the range of 85 micrometers to 550 micrometers including all values and ranges therein when the cathode material is formed on one side of the cathode current collector 152. When the cathode material is formed on both sides of the cathode current collector 152, the cathode electrode 157 exhibits a thickness in the range of 165 micrometers to 1050 micrometers including all values and ranges therein for a double sided cathode electrode 157, such as in the range of 205 micrometers to 500 micrometers.

The anode 158 includes active anode materials that can undergo reversible insertion or intercalation of lithium ions at a lower electrochemical potential than the cathode 156 material, such that an electrochemical potential difference exists between the anode 158 and cathode 156. The active anode material includes one or more of silicon, silicon-carbon composite, hard carbon (non-graphitizing carbon), graphite, silicon oxide (SiOx, wherein x is either 1 or 2), and lithium titanate (LTO). In embodiments, the anode is formed by vapor depositing, through either physical or chemical vapor deposition, the anode active material on the anode current collector 154. Alternatively, the anode may be formed by forming a coating on the anode current collector 154, using a deposition process, such as a slurry based process, hot roll pressing process, extrusion or additive manufacturing. In embodiments, the anode 158 exhibits a thickness 420 in the range of 10 micrometers to 150 micrometers, including all values and ranges therein. In preferred embodiments, the anode is silicon deposited by physical vapor deposition exhibiting a thickness in the range of 1 micrometers to 100 micrometers, including all values and ranges therein such as 14 micrometers to 15 micrometers. The combined anode 158 and anode current collector 154 provide an anode electrode 159, which exhibits a thickness 422 in the range of 1 micrometers to 200 micrometers, including all values and ranges therein.

In alternative embodiments, the anode 158 is initially omitted and forms on the anode current collector 154 during the first charge cycle due to plating of lithium metal in situ. In such embodiments, the anode supported electrolyte separator 160 is disposed on and contacts the anode current collector 154 before the first charge cycle. Such embodiment is referred to as “anode free.”

As discussed above, the anode supported electrolyte separator 160 is sandwiched, or at least partially enclosed, between the cathode 156 and anode 158 preventing the cathode 156 from contacting the anode 158. The anode supported electrolyte separator 160 includes an electrolyte that provides a medium between the cathode 156 and anode 158 through which lithium ions travel yet electrically insulates the cathode 156 from the anode 158, preventing shorting. The anode supported electrolyte separator 160 is at least one of a solid state electrolyte or a semi-solid state electrolyte.

A solid state electrolyte is understood as an electrolyte that exhibits a solid state of matter. The anode supported solid state electrolyte separator 160 includes a sulfidic solid state electrolyte, such as a lithium-phosphorus-sulfur (LPS) electrolyte or a lithium-phosphorus-sulfur-oxygen (LPSO) electrolyte. In embodiments, the anode supported solid state electrolyte separator 160 includes one or more of the following electrolyte compositions: yLi₂S·(100-y-x)P₂S₅·xP₂O₅ wherein y is in the range of 70 mole (mol) percent to 80 mol percent including all values and ranges therein and x is in the range of 1 mol percent to 10 mol percent including all values and ranges therein (LPSO), Li₁₀MP₂S₁₂ wherein M is at least one of Si, Ge, and Sn (LPS), and argyrodite having the formula: A₁₂₋ₘ₋ₓ⁺(M^{m+}Y₄²⁻)Y₂₋ₓ²⁻Xₓ⁻, wherein A⁺=Li⁺, Cu⁺, Ag⁺; M^{m+}=Si⁴⁺, Ge⁴⁺, Sn⁴⁺, P⁵⁺, As⁵⁺; Y²⁻=O²⁻, S²⁻, Se²⁻, Te²⁻; and X⁻=Cl, Br⁻, I^{;} 0≤x≤2, such as Li₆PS₅Cl. The electrolyte composition is present in the range of 50 percent by weight to 99 percent by weight of the total weight of the anode supported solid state electrolyte separator 160, including all values and ranges therein. Further, the anode supported solid state electrolyte separator 160 includes an electrolyte binder present in the range of 1 percent by weight to 50 percent by weight of the total weight of the solid state electrolyte separator, including all values and ranges therein. The electrolyte binder includes one or more of the following binders: styrene butadiene rubber (SBR), hydrogenated nitrile butadiene rubber (HNBR), polyvinylidene fluoride (PVDF), poly(vinylidene fluoride-co-hexafluoropropylene) (PVDF-HFP), polytetrafluoroethylene (PTFE), poly(tetrafluoroethylene-co-perfluoro(3-oxa-4-pentenesulfonic acid)) lithium salt, and combinations thereof. Further, in embodiments, the solid state electrolyte and electrolyte binder are deposited on the anode 158 in a slurry of the electrolyte mixed with the binder in a solution of the binder and a binder solvent. The binder solvent is selected from one or more of the following solvents: toluene, alkane, anisole, and organophosphate. In embodiments, the solid state electrolyte is present in the slurry in the range of 28 percent by weight to 60 percent by weight of the total weight of the slurry, including all values and increments therein. The electrolyte binder is present in the solution in the range of 0.4 percent by weight to 18 percent by weight of the total weight of the solution including all values and ranges therein. The anode supported solid state electrolyte separator 160 exhibits a thickness 424 in the range of 1 micrometers to 100 micrometers, including all values and ranges therein. Further, the anode supported solid state electrolyte separator 160 exhibits a porosity in the range of 1 percent to 50 percent of the total volume generally defined by the periphery of the anode supported solid state electrolyte separator 160 including all values and ranges therein.

In further or alternative embodiments, the anode supported electrolyte separator 160 includes a semi-solid state electrolyte. As understood herein, a semi-solid state electrolyte include a solid matrix including the anode supported solid state electrolyte separator infused with a liquid electrolyte in the interstices of the solid matrix and in some cases is described as a gel. In embodiments, the semi-solid state electrolyte includes a solvate ionic liquid electrolyte. The solvate ionic liquid electrolytes include one or more of the following solvate ionic liquid electrolytes: lithium triglyme bis(trifluoromethanesulfonyl)imide (Li[G3]TFSI), lithium tetraglyme bis(trifluoromethanesulfonyl)imide (Li[G4]TFSI), lithium triglyme bis(fluorosulfonyl)imide (Li[G3]FSI), lithium tetraglyme bis(fluorosulfonyl)imide (Li[G4]FSI), lithium triglyme bis(pentafluoroethenesulfonyl)imide (Li[G3]BETI), lithium tetraglyme bis(pentafluoroethenesulfonyl)imide (Li[G4]BETI), lithium triglyme cyclic-TFSI derivative 1,2,3-dithiazolidine-4,4,5,5-tetrafluoro-1,1,3,3-tetraoxide (Li[G3]CTFSI), lithium tetraglyme cyclic-TFSI derivative 1,2,3-dithiazolidine-4,4,5,5-tetrafluoro-1,1,3,3-tetraoxide (Li[G4]CTFSI), lithium triglyme perchlorate (Li[G3]ClO₄), lithium tetraglyme perchlorate (Li[G4]ClO₄), lithium triglyme tetrafluoroborate (Li[G3]BF₄), and lithium tetraglyme tetrafluoroborate (Li[G4]BF₄). The semi-solid electrolyte is formed by applying the solvate ionic liquid electrolyte onto the anode supported solid state electrolyte separator. The solvate ionic liquid electrolyte infiltrates into the interstices of the solid matrix, which may be as assisted by applying a vacuum. The solvate ionic liquid electrolyte may be applied before the anode supported electrolyte separator is assembled into the battery cell or the anode supported electrolyte separator is assembled into the battery cell. If applied before assembly, excess solvate ionic liquid electrolyte is removed prior to assembly. The anode supported semi-solid state electrolyte separator 160 exhibits a thickness 424 in the range of 1 micrometers to 100 micrometers, including all values and ranges therein.

In optional embodiments, the anode supported electrolyte separator 160, including one or more solvate liquid electrolytes, also includes at least one of a liquid electrolyte diluent and a room temperature ionic liquid. Liquid electrolyte diluents include fluorinated ether electrolytes. Fluorinated ether electrolytes include one or more of the following: 1,1,2,2-tetrafluoroethylene 2,2,3,3-tetrafluoropropyl ether (TTE), bis(2,2,2-trifluoroethyl) ether (BTFE), tris(2,2,2-trifluoroethyl)orthoformate (TFEO), fluorobenzene (FB), and 1,2-difluorobenzene (DFB), bis(2,2-difluoroethyl) ether (BDE), ethyl 1,1,2,2-tetrafluoroethyl ether (ETE), hexafluoroisopropyl methyl ether (HFME), 1,1,2,2-tetrafluoroethyl 2,2,2-trifluoroethyl ether, ethyl 1,1,2,3,3,3-hexafluoropropyl ether, methyl nonafluorobutyl ether (mixture of isomers), difluoromethyl 2,2,3,3-tetrafluoropropyl ether, 1H,1H,5H-octafluoropentyl 1,1,2,2-tetrafluoroethyl ether (OTE), 1,1,2,3,3,3 hexafluoropropyl-2,2,2-trifluoroethyl ether, 1,1,1,2,2,3,4,5,5,5-decafluoro-3-methoxy-4-(trifluoromethyl)pentane, fluoromethyl 1,1,1,3,3,3-hexafluoroisopropyl ether, 1,1,2,3,3,3-hexafluoropropyl methyl ether, methyl 2,2,3,3,3-pentafluoropropyl ether, and methyl 1,1,2,2-tetrafluoroethyl ether. The liquid electrolyte diluents and solvate ionic liquid electrolyte assist in increasing contact between the solid state electrolyte separators and the cathode and anode by filling in interstices formed by the process of depositing the cathode 156 and anode 158 on the cathode current collector 152 and the anode current collector 154, respectively. Room temperature ionic liquids are understood as ionic systems exhibiting a liquid state of matter at room temperature. Room temperature ionic liquids include, for example, one or more of the following: 1-ethyl-3-methylimidazolium bis(trifluoromethylsulfonyl)imide (EMIM-TFSI), 1-butyl-3-methylimidazolium bis(trifluoromethylsulfonyl)imide (BMIM-TFSI), N-propyl-N-methylpyrrolidinium bis(trifluoromethanesulfonyl)imide (PYR13TFSI), 1-butyl-1-methylpyrrolidinium bis(trifluoromethanesulfonyl)imide (PYR14TFSI), 1-ethyl-3-methylimidazolium bis(fluorosulfonyl)imide (EMIM-FSI), 1-butyl-3-methylimidazolium bis(fluorosulfonyl)imide (BMIM-FSI), N-propyl-N-methylpyrrolidinium bis(fluorosulfonyl)imide (PYR13-FSI), and 1-butyl-1-methylpyrrolidinium bis(fluorosulfonyl)imide (PYR14-FSI). In embodiments, the ratio of at least one of the liquid electrolytes and room temperature ionic liquids to at least one of the solid state electrolyte and semi-solid state electrolyte is in the range of 1 part by volume to 1 part by volume to 5 parts by volume to 1 part by volume, including all values and ranges therein.

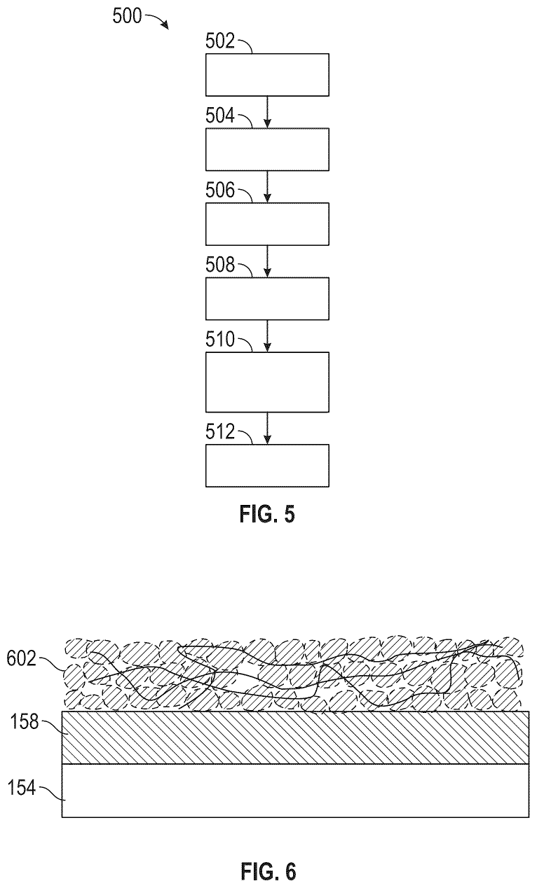

Turning now to FIG. 5, with reference to FIGS. 2A through 4B, an embodiment of a method of forming an anode-supported electrolyte is described. The method 500 includes at block 502 mixing one or more electrolytes, one or more electrolyte binders, and one or more binder solvents to form a slurry. In embodiments, the slurry is mixed for a period in the range of 10 minutes to 30 minutes including all values and ranges therein at a temperature in the range of 21 degrees Celsius to 25 degrees Celsius including all values and ranges therein. At block 504 the slurry is coated on the anode and allowed to dry. In embodiments, drying occurs at a temperature in the range of 60 degrees Celsius to 150 degrees Celsius including all values and ranges therein, such as 80 degrees Celsius for a period of time in the range of 1 hour to 48 hours including all values and ranges therein. FIG. 6 illustrates the coating 602 deposited on the anode 154. Returning to FIG. 5, at block 506, the coating 602 is calendared at a pressure of greater than 100 megapascals, such as in the range of 100 megapascals to 600 megapascals, including all values and ranges therein. At block 508, optionally, at least one of the solvate ionic liquid electrolytes, liquid electrolyte diluents, and room temperature ionic liquids are applied to the anode supported electrolyte separator 160, the liquid is allowed to infiltrate the anode supported electrolyte separator 160, which may be assisted by vacuum, and any excess is removed. At block 510, the anode electrode including the anode supported electrolyte separator 160 is assembled into a battery cell 150. As an alternative to optional block 508, at block 512, optionally, at least one of the solvate ionic liquid electrolytes, liquid electrolyte diluents, and room temperature ionic liquids at added to the battery cell 150 after the battery cell 150 is assembled and sealed.

### Comparative Example

Three 2032 coin cells were formed using a traditional polymer separator, a cathode supported solid state electrolyte separator, and an anode supported solid state electrolyte separator. All three battery cells 700, 800, 400, illustrated in FIGS. 7, 8 and 4 respectively, included an aluminum cathode current collector 152, a copper anode current collector 154, and a silicon anode 158 having an energy density of 4.4 milliamp-hours per square centimeter. The cathode 156 for all three battery cells included 6 parts by weight of Li₂S and carbon black (including Li₂S is present at 70 percent by weight active cathode material and carbon black is present at 30 percent by weight of the total weight of the active cathode material) to 2.5 parts by weight LPSO 70Li₂S·25P₂S₅·5P₂O₅ to 1 part by weight carbon black to 0.5 parts by weight hydrogenated nitrile butadiene rubber. The cathode was applied at a loading of 2 to 3 milligrams per square centimeters.

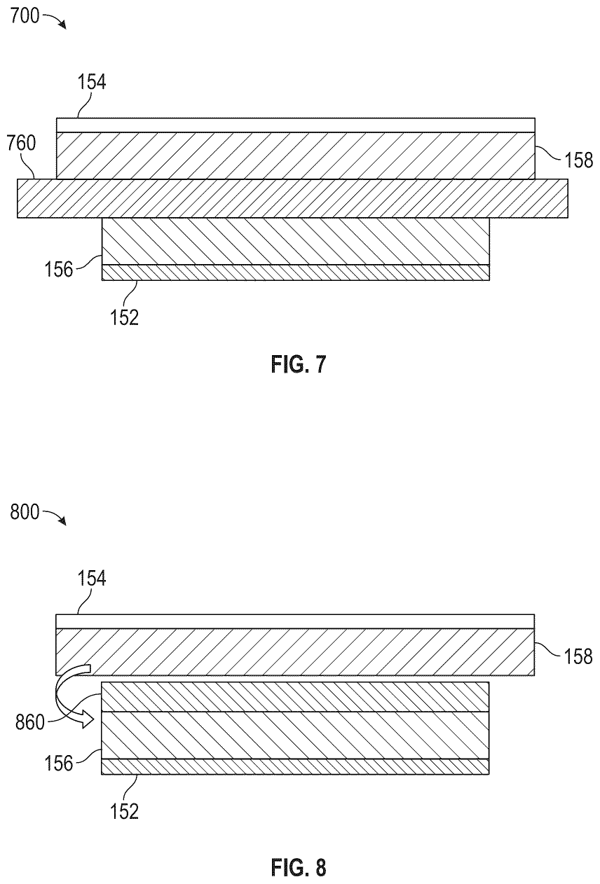

Turning now to FIG. 7, the figure illustrates a traditional battery cell 700 including a traditional polymer separator 760 formed from an ENTEK ultra high molecular weight polyethylene (UHMWPE) silica fused separator. FIG. 8 illustrates a battery cell 800 including a cathode supported solid state electrolyte separator. The cathode supported solid state electrolyte separator 860 included LPSO 70Li₂S·25P₂S₅·5P₂O₅ and was applied to the cathode as a 25 micrometer film. The anode supported solid state electrolyte separator 160, illustrated in FIG. 4A, included LPSO applied to the anode as a 25 micrometer film.

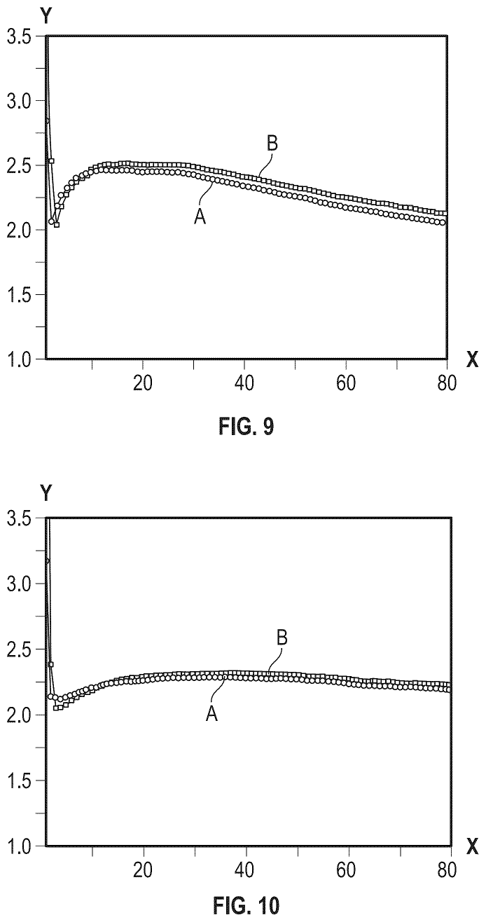

FIG. 9 illustrates the decay in charge (line A) and discharge (line B) capacity (milli-Amp hours) (illustrated on the y-axis) of the traditional battery cell 700 over 80 cycles (illustrated on the x-axis) at a charge rate of C/10 (10 hours of charging) and a discharge rate of C/10 (10 hours of discharging). FIG. 10 illustrates the decay in charge (line A) and discharge (line B) capacity (milli-Amp hours) (illustrated on the y-axis) of the battery cell 400 including the anode supported solid electrolyte separator 160 over 80 cycles (illustrated on the x-axis) at a charge rate of C/10 and a discharge rate of C/10. As illustrated, the capacity of both battery cells did not significantly decay over the 80 cycles. The battery cell including the cathode supported solid state electrolyte suffered from edge shorting preventing the measurement of the capacity as a function of charge/discharge cycle.

The electrolytes, battery cells, secondary batteries, and methods of making described herein offer a number of advantages. These advantages include, for example, the prevention of shorts in the battery cell caused by contact of the anode with the cathode. These advantages also include the provision of an anode material that is mechanically robust enough for the calendaring process used in depositing the anode supported electrolyte separator. These advantages further include the ability to reduce the separator thickness to increase cell energy density. In addition, these advantages include the ability to apply the technology to both unipolar and bipolar battery cell designs.

As used herein, the term “controller” and related terms such as microcontroller, control module, module, control, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.). The controller 132 may also consist of multiple controllers which are in electrical communication with each other. The controller 132 may be inter-connected with additional systems and/or controllers of the vehicle 100, allowing the controller 132 to access data such as, for example, speed, acceleration, braking, and steering angle of the vehicle 100.

A processor may be a custom made or commercially available processor, a central processing unit (CPU), a graphics processing unit (GPU), an auxiliary processor among several processors associated with the controller 132, a semi composite conductor-based microprocessor (in the form of a microchip or chip set), a macroprocessor, a combination thereof, or generally a device for executing instructions.

The tangible, non-transitory memory 134 may include volatile and nonvolatile storage in read-only memory (ROM), random-access memory (RAM), and keep-alive memory (KAM), for example. KAM is a persistent or non-volatile memory that may be used to store various operating variables while the processor is powered down. The tangible, non-transitory memory 134 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 132 to control various systems of the vehicle 100.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An anode electrode for a battery cell, comprising:
an anode current collector including a first surface; and
an anode supported electrolyte separator disposed on the first surface,
wherein the anode supported electrolyte separator includes at least one electrolyte selected from the following compositions: a) yLi₂S·(100-y-x)P₂S₅·xP₂O₅ wherein y is in the range of 70 mole percent to 80 mole percent and x is in the range of 1 mole percent to 10 mole percent, b) Li₁₀MP₂S₁₂ wherein M is at least one of Si, Ge, and Sn, and c) argyrodite exhibiting the composition: A₁₂₋ₘ₋ₓ⁺(M^{m+}Y₄²⁻)Y₂₋ₓ²⁻Xₓ⁻ wherein A⁺=Li⁺, Cu⁺, Ag⁺; M^{m+}=Si⁴⁺, Ge⁴⁺, Sn⁴⁺, P⁵⁺, As⁵⁺; Y²⁻=O²⁻, S²⁻, Se²⁻, Te²⁻; X⁻=Cl⁻, Br⁻, I⁻; and 0≤x≤2,
wherein the anode supported electrolyte separator exhibits a thickness in the range of 1 micrometers to 100 micrometers.

2. The anode electrode of claim 1, wherein the anode supported electrolyte separator includes a second surface defining a second area, wherein the second area is larger than a third area defined by a third surface of an adjacent cathode.

3. The anode electrode of claim 2, wherein the anode supported electrolyte separator contacts the first surface of the anode current collector.

4. The anode electrode of claim 2, further comprising an anode contacting the first surface, wherein the anode includes a fourth surface defining a fourth area, and the anode supported electrolyte separator contacts the fourth surface.

5. The anode electrode of claim 4, wherein the anode includes one or more active anode materials selected from the group consisting of: silicon, silicon-carbon composite, hard carbon, graphite, silicon oxide (SiOx, wherein x is either 1 or 2), and lithium titanate (LTO).

6. The anode electrode of claim 5, wherein the anode includes silicon exhibiting a thickness in the range of 1 micrometers to 100 micrometers.

7. The anode electrode of claim 1, wherein the electrolyte is yLi₂S·(100-y-x)P₂S₅·xP₂O₅ wherein y is in the range of 70 mole percent to 80 mole percent and x is in the range of 1 mole percent to 10 mole percent and the electrolyte is present in the range of 50 percent by weight to 99 percent by weight of the total weight of the anode supported electrolyte separator and the anode supported electrolyte separator further includes an electrolyte binder present in the range of 1 percent by weight to 50 percent by weight of the total weight of the anode supported electrolyte separator.

8. The anode electrode of claim 7, wherein the electrolyte binder includes one or more binders selected from the group consisting of: styrene butadiene rubber (SBR), hydrogenated nitrile butadiene rubber (HNBR), polyvinylidene fluoride (PVDF), poly(vinylidene fluoride-co-hexafluoropropylene) (PVDF-HFP), polytetrafluoroethylene (PTFE), and poly(tetrafluoroethylene-co-perfluoro(3-oxa-4-pentenesulfonic acid)) lithium salt.

9. The anode electrode of claim 1, wherein the anode supported electrolyte separator further includes one or more liquid electrolyte diluents selected from the group consisting of: 1,1,2,2-tetrafluoroethylene 2,2,3,3-tetrafluoropropyl ether (TTE), bis(2,2,2-trifluoroethyl) ether (BTFE), tris(2,2,2-trifluoroethyl)orthoformate (TFEO), fluorobenzene (FB), 1,2-difluorobenzene (DFB), bis(2,2-difluoroethyl) ether (BDE), ethyl 1,1,2,2-tetrafluoroethyl ether (ETE), hexafluoroisopropyl methyl ether (HFME), 1,1,2,2-tetrafluoroethyl 2,2,2-trifluoroethyl ether, ethyl 1,1,2,3,3,3-hexafluoropropyl ether, methyl nonafluorobutyl ether (mixture of isomers), difluoromethyl 2,2,3,3-tetrafluoropropyl ether, 1H,1H,5H-octafluoropentyl 1,1,2,2-tetrafluoroethyl ether (OTE), 1,1,2,3,3,3 hexafluoropropyl-2,2,2-trifluoroethyl ether, 1,1,1,2,2,3,4,5,5,5-decafluoro-3-methoxy-4-(trifluoromethyl)pentane, fluoromethyl 1,1,1,3,3,3-hexafluoroisopropyl ether, 1,1,2,3,3,3-hexafluoropropyl methyl ether, methyl 2,2,3,3,3-pentafluoropropyl ether, and methyl 1,1,2,2-tetrafluoroethyl ether.

10. The anode electrode of claim 1, wherein the anode supported electrolyte separator further includes one or more room temperature ionic liquids selected from the group consisting of: 1-ethyl-3-methylimidazolium bis(trifluoromethylsulfonyl)imide (EMIM-TFSI), 1-butyl-3-methylimidazolium bis(trifluoromethylsulfonyl)imide (BMIM-TFSI), N-propyl-N-methylpyrrolidinium bis(trifluoromethanesulfonyl)imide (PYR13TFSI), 1-butyl-1-methylpyrrolidinium bis(trifluoromethanesulfonyl)imide (PYR14TFSI), 1-ethyl-3-methylimidazolium bis(fluorosulfonyl)imide (EMIM-FSI), 1-butyl-3-methylimidazolium bis(fluorosulfonyl)imide (BMIM-FSI), N-propyl-N-methylpyrrolidinium bis(fluorosulfonyl)imide (PYR13-FSI), and 1-butyl-1-methylpyrrolidinium bis(fluorosulfonyl)imide (PYR14-FSI).

11. The anode electrode of claim 1, wherein the anode supported electrolyte separator includes one or more solvate ionic liquid electrolytes selected from the group consisting of: lithium triglyme bis(trifluoromethanesulfonyl)imide (Li[G3]TFSI), lithium tetraglyme bis(trifluoromethanesulfonyl)imide (Li[G4]TFSI), lithium triglyme bis(fluorosulfonyl)imide (Li[G3]FSI), lithium tetraglyme bis(fluorosulfonyl)imide (Li[G4]FSI), lithium triglyme bis(pentafluoroethenesulfonyl)imide (Li[G3]BETI), lithium tetraglyme bis(pentafluoroethenesulfonyl)imide (Li[G4]BETI), lithium triglyme cyclic-TFSI derivative 1,2,3-dithiazolidine-4,4,5,5-tetrafluoro-1,1,3,3-tetraoxide (Li[G3]CTFSI), lithium tetraglyme cyclic-TFSI derivative 1,2,3-dithiazolidine-4,4,5,5-tetrafluoro-1,1,3,3-tetraoxide (Li[G4]CTFSI), lithium triglyme perchlorate (Li[G3]ClO₄), lithium tetraglyme perchlorate (Li[G4]ClO₄), lithium triglyme tetrafluoroborate (Li[G3]BF₄), and lithium tetraglyme tetrafluoroborate (Li[G4]BF₄).

12. A battery cell for use in a vehicle battery, comprising:
an anode current collector including a first surface;
an anode supported electrolyte separator disposed on the first surface, the anode supported electrolyte separator including a second surface defining a second area; and
a cathode adjacent to the second surface of the anode supported electrolyte separator, the cathode including a third surface defining a third area;
wherein the second area is greater than the third area and the anode supported electrolyte separator includes an overhang that extends beyond the third area of the cathode, wherein the anode supported electrolyte separator exhibits a thickness in the range of 1 micrometers to 100 micrometers, and
wherein the anode supported electrolyte separator includes at least one of the following electrolyte compositions: a) yLi₂S·(100-y-x)P₂S₅·xP₂O₅ wherein y is in the range of 70 mole percent to 80 mole percent and x is in the range of 1 mole percent to 10 mole percent, b) Li₁₀MP₂S₁₂ wherein M is at least one of Si, Ge, and Sn, and c) argyrodite exhibiting the following composition: A₁₂₋ₘ₋ₓ⁺(M^{m+}Y₄²⁻)Y₂₋ₓ²⁻Xₓ⁻, wherein A⁺=Li⁺, Cu⁺, Ag⁺; M^{m+}=Si⁴⁺, Ge⁴⁺, Sn⁴⁺, P⁵⁺, As⁵⁺; Y²⁻=O²⁻, S²⁻, Se²⁻, Te²⁻; X⁻=Cl⁻, Br⁻, I⁻; and 0≤x≤2, present in the range of 50 percent by weight to 99 percent by weight of the total weight of the anode supported electrolyte separator, and an electrolyte binder present in the range of 1 percent by weight to 50 percent by weight of the total weight of the anode supported electrolyte separator.

13. The battery cell of claim 12, wherein the anode supported electrolyte separator contacts the anode current collector.

14. The battery cell of claim 12, further comprising an anode including silicon and a fourth surface defining a fourth area, the anode contacting the first surface of the anode current collector and the anode supported electrolyte separator contacting the fourth surface of the anode.

15. The battery cell of claim 12, wherein the overhang is in the range of 1 millimeter to 2 millimeters.

16. The battery cell of claim 12, wherein the anode current collector is a bipolar current collector.

17. The battery cell of claim 12, further comprising a cathode current collector, wherein the cathode contacts the cathode current collector.

18. The battery cell of claim 12, wherein the cathode includes an active cathode material, a cathode electrolyte, and a cathode binder, wherein the active cathode material is present in the range of 64 percent by weight to 98.5 percent by weight of the total weight of the cathode, the cathode binder present in the range of 1 percent by weight to 9 percent by weight of the total weight of the cathode, and the cathode electrolyte is present in the range of 10 percent by weight to 17 percent by weight of the total weight of the cathode, wherein the active cathode material includes one or more active cathode materials selected from the following: lithium iron phosphate (LFP), sulfur(S), iron sulfide (FeS₂), and lithium sulfide (Li₂S), and the cathode binder includes one or cathode binders selected from the group consisting of styrene butadiene rubber (SBR), hydrogenated nitrile butadiene rubber (HNBR), polyvinylidene (PVDF), fluoride poly(vinylidene fluoride-co-hexafluoropropylene) (PVDF-HFP), polytetrafluoroethylene (PTFE) poly(ethylene oxide) (PEO) and poly(tetrafluoroethylene-co-perfluoro(3-oxa-4-pentenesulfonic acid)) lithium salt, and the cathode electrolyte includes yLi₂S·(100-y-x)P₂S₅·xP₂O₅ wherein y is in the range of 70 mole percent to 80 mole percent and x is in the range of 1 mole percent to 10 mole percent.

19. The battery cell of claim 14, wherein the anode supported electrolyte separator includes a room temperature ionic liquid and the room temperature ionic liquid is selected form one or more of the following room temperature ionic liquids: 1-ethyl-3-methylimidazolium bis(trifluoromethylsulfonyl)imide (EMIM-TFSI), 1-butyl-3-methylimidazolium bis(trifluoromethylsulfonyl)imide (BMIM-TFSI), N-propyl-N-methylpyrrolidinium bis(trifluoromethanesulfonyl)imide (PYR13TFSI), 1-butyl-1-methylpyrrolidinium bis(trifluoromethanesulfonyl)imide (PYR14TFSI), 1-ethyl-3-methylimidazolium bis(fluorosulfonyl)imide (EMIM-FSI), 1-butyl-3-methylimidazolium bis(fluorosulfonyl)imide (BMIM-FSI), N-propyl-N-methylpyrrolidinium bis(fluorosulfonyl)imide (PYR13-FSI), and 1-butyl-1-methylpyrrolidinium bis(fluorosulfonyl)imide (PYR14-FSI).

20. A method of forming an anode supported electrolyte separator, comprising:
forming a slurry of an electrolyte and an electrolyte binder in a binder solvent;
coating the slurry on one of a) a first surface of an anode current collector and b) a second surface of an anode;
drying the slurry to form an anode supported electrolyte separator; and
calendaring the anode supported electrolyte separator,
wherein the at least one electrolyte includes a composition selected from the group consisting of: a) yLi₂S·(100-y-x)P₂S₅·xP₂O₅ wherein y is in the range of 70 mole percent to 80 mole percent and x is in the range of 1 mole percent to 10 mole percent, b) Li₁₀MP₂S₁₂ wherein M is at least one of Si, Ge, and Sn, and c) argyrodite exhibiting the following composition: A₁₂₋ₘ₋ₓ⁺(M^{m+}Y₄²⁻)Y₂₋ₓ²⁻Xₓ⁻ wherein A⁺=Li⁺, Cu⁺, Ag⁺; M^{m+}=Si⁴⁺, Ge⁴⁺, Sn⁴⁺, P⁵⁺, As⁵⁺; Y²⁻=O²⁻, S²⁻, Se²⁻, Te²⁻; X⁻=Cl⁻, Br⁻, I⁻; and 0≤x≤2, and wherein the anode supported electrolyte separator exhibits a thickness in the range of 1 micrometers to 100 micrometers.
